(19) United States
(12) Patent Application Publication
(10) Pub. No.: US 2021/0005033 A1
(43) Pub. Date: Jan. 7, 2021

(54) SMART LOCK BOX AND SYSTEM

(71) Applicants: Roy Roman, Toronto (CA); Ammar Oudeh, Toronto (CA); Richard Cascone, Richmond Hills (CA); Andrew Namrud, Aurora (CA)

(72) Inventors: Roy Roman, Toronto (CA); Ammar Oudeh, Toronto (CA); Richard Cascone, Richmond Hills (CA); Andrew Namrud, Aurora (CA)

(21) Appl. No.: 16/504,309

(22) Filed: Jul. 7, 2019

(51) Int. Cl. G07C 9/00; G06Q 10/08; E06B 7/32; E05B 47/00; A47G 29/14

(52) U.S. Cl. CPC G07C 9/00896; G06Q 10/0833; G06F 21/30; E05B 47/0001; A47G 29/141; E06B 7/32

(57) ABSTRACT

A delivery box system for use by a user with a delivery box having an internal compartment, a door providing access into the internal compartment and a locking mechanism configured to lock and unlock the door. The system having a user module configured to receive and store user data. A tracking module is configured to receive, and store authorized incoming package tracking data. An authorization module is configured to receive a request to unlock the locking mechanism of delivery box to determine if the request is authorized. A locking module is configured to engage the locking mechanism upon a determination that the request to unlock the locking mechanism is authorized. An activity module is configured to create and store an activity record for all activity associated with the delivery box. The activity record includes a time and a date of all successful and unsuccessful attempts to gain access to the compartment. A communication module is configured to provide and store two-way audio and video communication between a person located at the delivery box and a remotely located person.

### REFERENCE TO PENDING APPLICATIONS

This application does not claim the benefit of any issued U.S. patent or pending application.

### BACKGROUND OF THE INVENTION

### Field of the Invention

The present invention generally relates to a lock box, and more specifically, to a lock box having automated and remotely controlled features.

### Background

The delivery of the packages and parcels to a postal address while the recipient is away has become a standard practice and has grown due to the increase of online consumer shopping. This delivery practices occurs when a sender does not require the recipient to be present at the time of delivery, and as such, the delivery person leaves the package at the postal address, usually on a front porch or other easily accessible location. This delivery practice, however, has given rise to an increase of theft of these packages and parcels.

Accordingly, there is a need for a service which can satisfy the need set out above.

### BRIEF SUMMARY OF THE INVENTION

According to an aspect of the present invention, a lock box having automated and remotely controlled features is disclosed.

In one aspect, a delivery box is disclosed. The delivery box includes a door providing access to a compartment, a first locking mechanism configured to lock and unlock the first door; and a computer device having a processor and a memory configured for engaging the first locking mechanism to lock and unlock the first door. The locking mechanism may be an electronic lock configured to operate upon receiving authenticated electronic key input or a combination electronic and mechanical lock configured to operate by a combination of a physical key and electronic key input.

In other aspects, the delivery box of claim 1 may also include a parcel scanning device configured to scan encoded parcel tracking numbers, a camera configured to provide video coverage of the delivery box, a communication device configured to provide two-way communication between a person located at the delivery box and a remotely located person, an input device, such as a keypad or a biometric input device configured to provide direct input to the computer device and an exterior light configured to provide illumination to the exterior of the delivery box.

In some aspects, the delivery box may also include a second door providing access to the storage space. In these aspects, the computer device is further configured for engaging the second locking mechanism to lock and unlock the second door.

In some aspects, a delivery box system for use by a user with a delivery box having an internal compartment, a door providing access into the internal compartment and a locking mechanism configured to lock and unlock the door is disclosed. The system includes a user module configured to receive and store user data, a tracking module configured to receive and store authorized incoming package tracking data and an authorization module configured to receive a request to unlock the locking mechanism of delivery box and configured to determine if the request is authorized. Once the request has been authorized, a locking module that is configured to engage the locking mechanism unlocks the locking mechanism allowing access into the compartment.

In some aspects, an activity module is disclosed. The activity module is configured to create and store an activity record for all activity associated with the delivery box. The activity record may include a time and a date of all successful and unsuccessful attempts to gain access to the compartment, as well as a video record of the such attempts. Further, the activity module is configured to send the activity record to the user and to an external storage device. Further, the activity module is configured to send a notification to the user when the activity record is modified. For example, upon an unsuccessful attempt to open the delivery box, the activity module may send a video of person who unsuccessfully attempted to open the delivery box to a storage device that is associated within a Cloud server and may send the user a notification of the unsuccessful attempt.

In some aspects, a communication module is disclosed. The communication module is configured to provide and store two-way audio and video communication between a person located at the delivery box and a remotely located person.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention wherein similar characters of reference denote corresponding parts in each view,

FIG. 1 is a front view of an embodiment of a delivery box of the present invention secured within a door.

FIG. 2 is a side, cut-away view of an embodiment of a delivery box of the present invention secured within a door with the access doors in the closed position.

FIG. 3 is a side, cut-away view of an embodiment of a delivery box of the present invention secured within a door with the access doors in the open position.

FIG. 4 is a perspective view of an embodiment of a delivery box of the present invention with the access doors in the closed position.

FIG. 5 is a perspective view of an embodiment of a delivery box of the present invention with the access doors in the open position.

FIG. 6 is a top, cut-away view of an embodiment of a delivery box of the present invention having a single door.

FIG. 7 is a top, cut-away view of an embodiment of a delivery box of the present invention having two doors.

FIG. 8 is a front view of an additional embodiment of a delivery box of the present invention secured within a garage door.

FIG. 9 is a side, cut-away view of an additional embodiment of a delivery box of the present invention secured within a door having an expandable internal compartment and with the access doors in the closed position.

FIG. 10 is a side, cut-away view of an additional embodiment of a delivery box of the present invention secured within a door having an expandable internal compartment and with the access doors in the open position.

FIG. 12 is a perspective view of an additional embodiment of a delivery box of the present invention having an expandable internal compartment and with the access doors in the closed position.

FIG. 13 is a perspective view of an embodiment of a delivery box of the present invention having an expandable internal compartment and with the access doors in the open position.

FIG. 14 schematic block diagram of a system in accordance with embodiments of the present invention.

FIG. 15 is a block diagram of a data processing system implementing a cuisine matching server in accordance with embodiments of the present invention.

FIG. 16 is a detailed block diagram of a data processing system implementing a cuisine matching server in accordance with embodiments of the present invention.

### DETAILED DESCRIPTION OF THE INVENTION

The present invention now will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

As will be appreciated by one of skill in the art, the present invention may be embodied as a method, data processing system, and/or computer program product. Accordingly, the present invention may take the form of an entirely hardware embodiment, an entirely software embodiment or an embodiment combining software and hardware aspects all generally referred to herein as a “circuit” or “module.” Furthermore, the present invention may take the form of a computer program product on a computer usable storage medium having computer-usable program code means embodied in the medium. Any suitable computer readable medium may be used including hard disks, CD-ROMs, optical storage devices, a transmission media such as those supporting the Internet or an intranet, or magnetic storage devices.

Computer program code for carrying out operations of the present invention may be written in an object oriented programming language, such as Java® or C++. However, the computer program code for carrying out operations of the present invention may also be written in conventional procedural programming languages, such as the “C” programming language or assembly language. The program code may execute entirely on the user's computer, partly on the user's computer, as a stand alone software package, partly on the user's computer and partly on a remote computer, or entirely on the remote computer. In the latter scenario, the remote computer may be connected to the user's computer through a local area network (LAN) or a wide area network (WAN).

The present invention is described below with reference to flowchart illustrations and/or block diagrams of methods, apparatus (systems) and computer program products according to some embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the acts specified in the flowchart and/or block diagram block or blocks.

These computer program instructions may also be stored in a computer-readable memory that can direct a computer or other programmable data processing apparatus to operate in a particular manner, such that the instructions stored in the computer-readable memory produce an article of manufacture including instruction means which implement the acts specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the acts specified in the flowchart and/or block diagram block or blocks.

Embodiments of the present invention will now be described with respect to the figures. Embodiments of the present invention provide methods, systems and/or computer program products for the management of a delivery box.

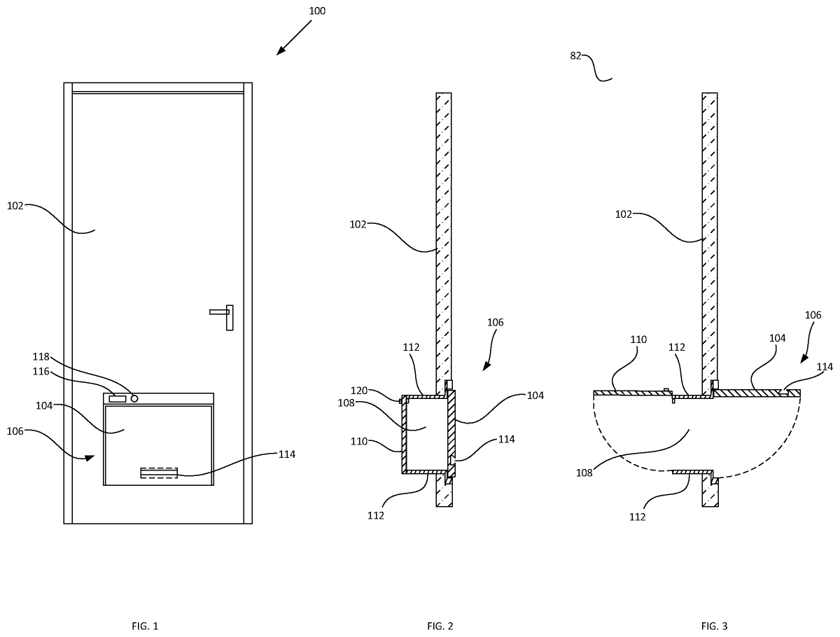

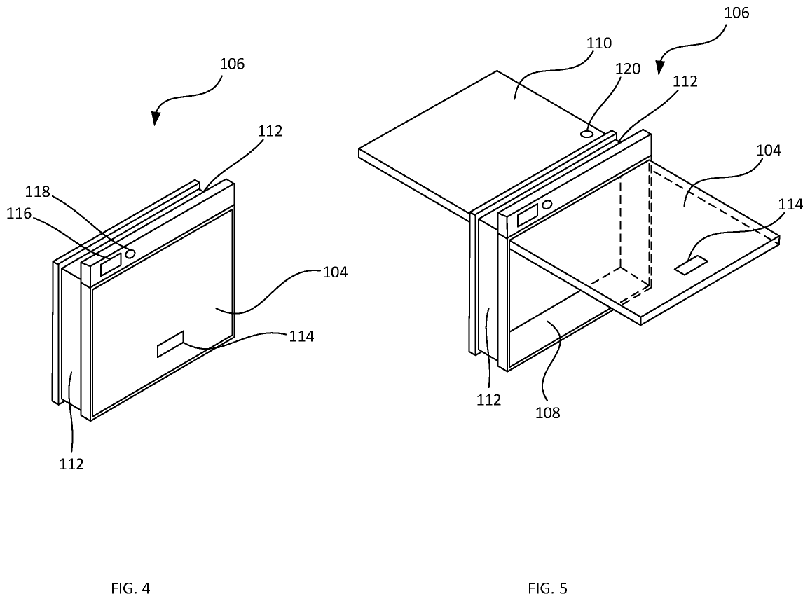

As illustrated in FIGS. 1-5, an embodiment of a delivery box 106 of the present invention is disclosed. Delivery box 106 includes a first door 104, a second door 110, compartment walls 112 that define an interior compartment 108. First door 104 and second door 110 provide access to internal compartment 108. In this embodiment, delivery box 106 is located within a door 102 to prevent its removal from its location. A handle 114 is included in the first door 104 to aid in the opening and closing of the door.

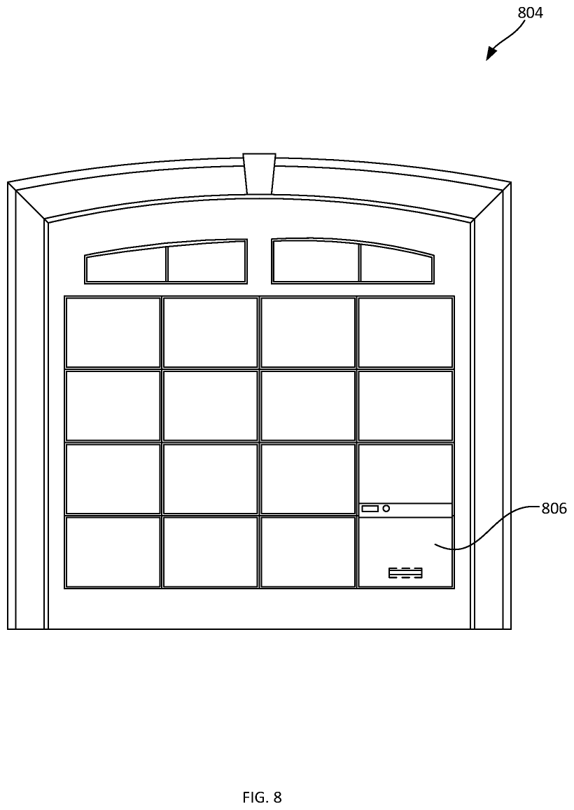

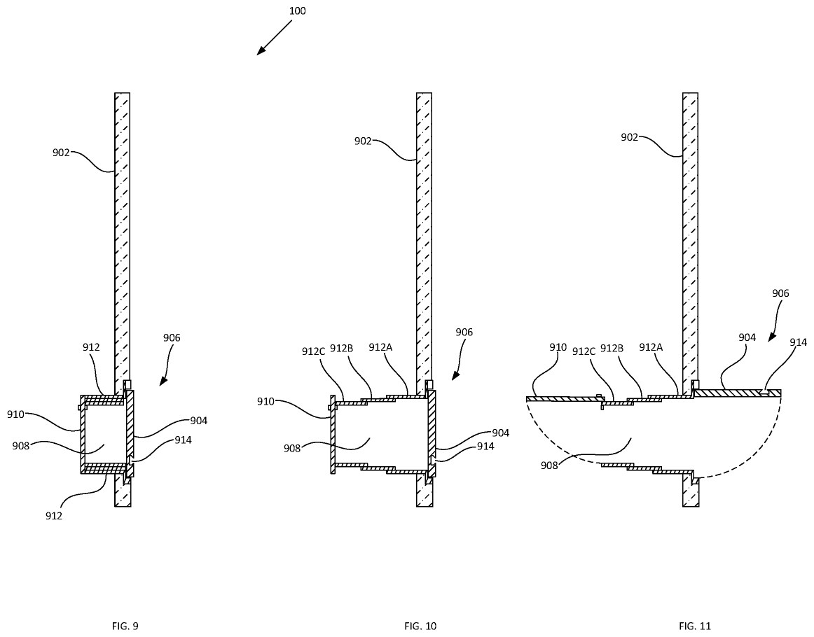

This configuration is illustrative and not meant to be limiting. Those skilled in the art will recognize that other configurations, such as but not limited to, a stand-alone box or a box secured to a pedestal are within the scope of the present invention. For example, a delivery box 806 may be located within a garage door 804, see FIG. 8.

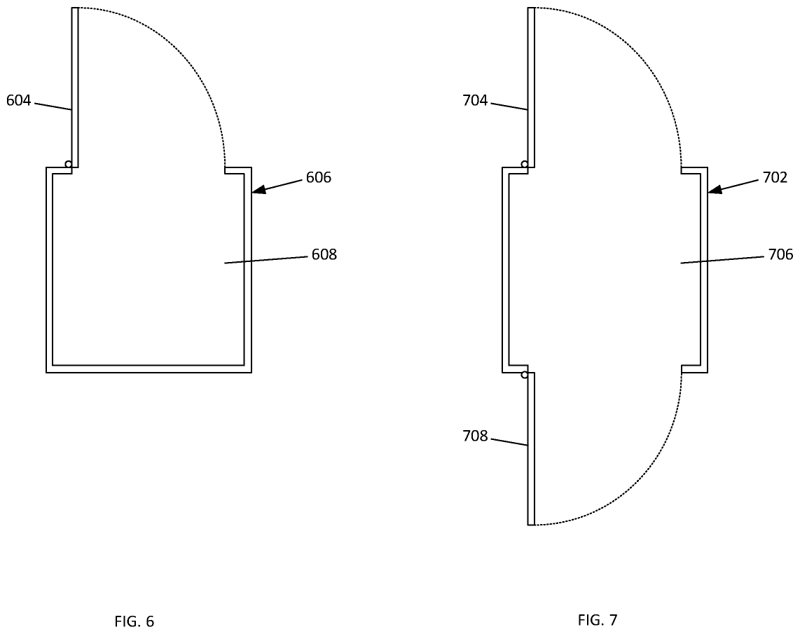

Some embodiments of the delivery box may have a single door. For example, as illustrated in FIG. 6, delivery box 606 includes a single door 604 that provides access to an internal compartment 808.

Further, in some embodiments of the delivery box may have multiple doors. For example, as illustrated in FIG. 7, an embodiment may include a delivery box 702 having a first door 704 and a second door 708, both of which allow access into an internal compartment 708. This configuration allows for greater control and security over access to the compartment 706. For example, delivery box 702 is located within an exterior door of a house, with the first door 704 being exposed to the exterior side of the door and the second door 708 being exposed to the interior side of the door. This allows access from the interior of the room upon which the door is affixed without having the need to open the door.

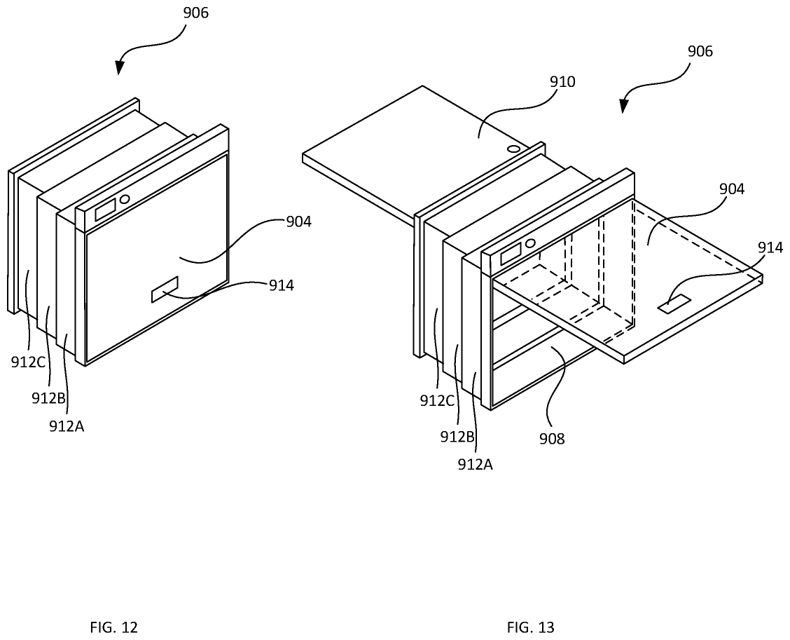

In some embodiments, internal compartment 108 may have a fixed dimension, as illustrated in FIGS. 1-5. In some embodiments, the internal compartment, however, may be adjustable. For example, as illustrated in FIGS. 9-13, an embodiment of delivery box 906 located within a door 902 and includes a first door 904, a second door 910 and telescoping expandable compartment walls 912 (individually identified as 912A, 912B and 912C) that define an interior compartment 908. The size of the interior compartment 908 can be changed based on the needs for the deliver box 906. In some situations, the compartment walls 912 can be compressed, as illustrated in FIG. 9. However, the telescoping relationship between the individual compartment walls 912A, 912B and 912C allow the size of the interior compartment to increase, as illustrated in FIG. 10.

Referring back to FIGS. 1-5, the first door 104 of the delivery box 106 may also include an electronic lock 116 configured to operate upon receiving authenticated electronic key input and/or mechanical lock 118. The second door 110 may have a mechanical lock 120. The inclusion of specific electronic locks and mechanical locks on the first and second doors is illustrative. Those skilled in the art will recognize that various electronic and mechanical locking mechanisms may be utilized and are within the scope of the invention.

Embodiments of the smart delivery box of the present invention may be constructed from any suitable material, including material that have an appropriate fire rating to prevent damage to the interior compartment in case of a fire.

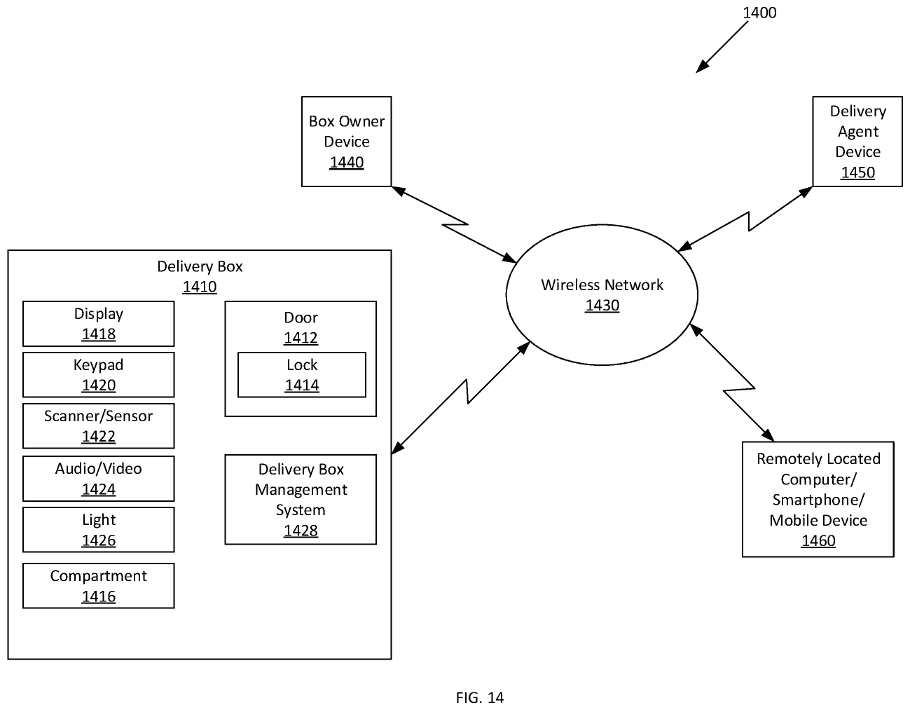

As illustrated in FIG. 14, a block diagram of an embodiment of a smart delivery box system 1400 of the present invention. The system 1400 includes a smart delivery box 1410 having a door 1412 to provide access to a compartment 1416 within the delivery box 1410 and an electrically operated locking mechanism 1414 to lock and unlock the door 1412. Locking mechanism 1414 may be activated either locally at the delivery box 1410 or remotely. The delivery box 1410 may be a mailbox, locker, or any other storage container. The delivery box 1410 is preferably secured to a fixed structure to prevent it from being removed without authorization. The delivery box 1410 may also include a display 1418, on which messages may be displayed to a user, a keypad 1420 to receive input from a user, and a scanner and/or sensor 1422 to detect and decode parcel tracking numbers and passkeys. The display 1418 may also comprise a touch screen allowing it both to present information and request input and to receive input using a virtual keypad, including entries that would otherwise be input through the keypad 1420, which may then be an optional component of the delivery box 1400. The scanner 1422 may read barcodes or quick response (QR) codes, or both, and the sensor may detect and read radio frequency (RFID) tags. The reference number “1420” will be used herein to refer to both to a virtual keypad that is integrated with a touch display and to a physical keypad.

The delivery box 1410 may also include one or more audio input devices such as a microphone, a video input device such as a camera, or both, 1424 to record activity about the delivery box 1410. Further, the microphone and/or camera 1424 may be used to facilitate two-way communication between a person located at the delivery box 1410 and a remotely located person.

The delivery box 1400 may be a single box at a residence, a business, or one of an array of lock boxes, such as for an apartment or condominium complex or office building. In addition to being available for receiving mailed or shipped parcels, the delivery box 1400 may be used to make parcels available for pickup by a carrier as well as for the delivery or pick up of food, medical and scientific lab specimens, and documents and parcels being transferred between internal departments of an organization.

Using a delivery box management system 1428 through a network 1430, the delivery box 1400 may communicate with other electronic devices, such as a box owner device 1440, which may be a personal computer, smartphone, or mobile device, a delivery agent's device 1450 and/or another remotely located personal computer, smartphone, or mobile device 1460. In some embodiments, network 1430 may be a local area network (LAN) or a wide area network (WAN) accessible over a wife or similar connection, or may be a wireless telecommunications network, such an LTE (4G) or NR (5G) network. The listing of these wife and telecommunication networks is illustrative and not meant to be limiting. Those skilled in the art will recognize that any communication network may be utilized and is within the scope of the present invention.

In some embodiments, the delivery box management system 1428 may be integrated into the delivery box 1410 while in other embodiments the delivery box management system 1428 may be a remotely located computer or server configured to communicate with any number of delivery boxes 1410.

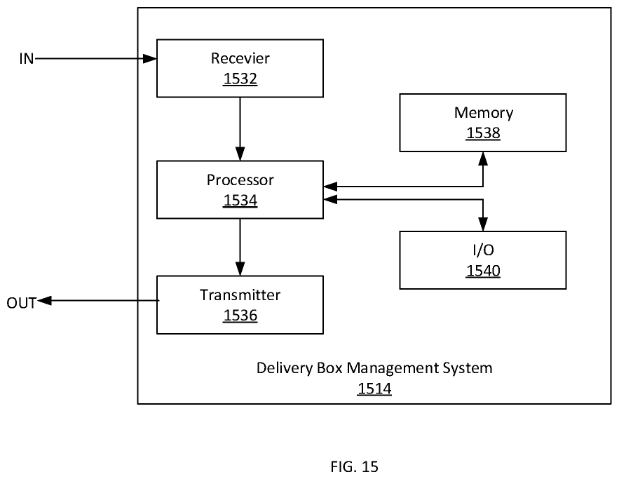

FIG. 15 is a more detailed diagram showing the overall components of a delivery box management system embedded in a delivery box according to the present invention. Referring now to FIG. 15, delivery box management system 1514 is preferably a short-range wireless system. Delivery box management system 1514 may include a receiver 1532, a processor 1534, a memory 1538 and a transmitter 1536. When a request for information is received from either box owner device 1516 or delivery agent device 1518, the request is preferably processed by processor 1534. Processor 1534 preferably accesses memory 1538 to fetch the requested information and transmits the information, as appropriate, via transmitter 1536. Delivery box management system 1514 is preferably powered by a power source, not shown. Delivery box management system 1514 may operate in standalone mode or in concert with other wireless short-range devices.

Delivery box management system 1514 may support such features as, for example receiving and storing user data, receiving and storing authorized incoming package tracking data, determining if a request to unlock the locking mechanism of delivery box is authorized and engaging the locking mechanism upon a determination that the request to unlock the locking mechanism is authorized. Inputs to delivery box management system 1514 may be made via voice (voice mail), locally input and/or remotely, for example via I/O 1540. For example, upon the input of an authorized bar code scan by a delivery agent through a scanner (e.g. the scanner 1422 in FIG. 14), delivery box management system 1514 may provide instructions to the electronic lock 1414 to release the lock allowing for access to compartment 1416 in FIG. 14.

Delivery box management system 1514 would typically be able to log and transmit successful and unsuccessful attempts to gain access into the compartment 1512.

Delivery box management system 1514 is also configured to determine when there is a successful and unsuccessful attempts to unlock the delivery box 1410. In the event of a successful attempt, delivery box management system 1514 may provide instructions to have audible sounds and/or lights indicated a successful attempt to be triggered. Likewise, in the event of a unsuccessful attempt, delivery box management system 1514 may provide instructions to have audible sounds and/or lights indicated a unsuccessful attempt to be triggered.

Memory 1538 preferably stores records of significant information and events such as the delivery of packages, the tracking data for packages, the identification of delivery companies and the identification of authorized persons for access purposes.

Preferably, receiver 1532 is capable of receiving information from box owner device 1516 or delivery agent device 1518. Such information can typically include, but is not limited to, requests to unlock the locking mechanism along with authentication data, such as passcode data, to authentic requests to unlock the locking mechanism.

In some embodiments, upon the successful delivery of a package, delivery box management system 1514 may also be configured provide a notification, such a text message or email, to the box owner, for example over the wireless network 1430 in FIG. 14, that the package has been delivered and is secured within the delivery box.

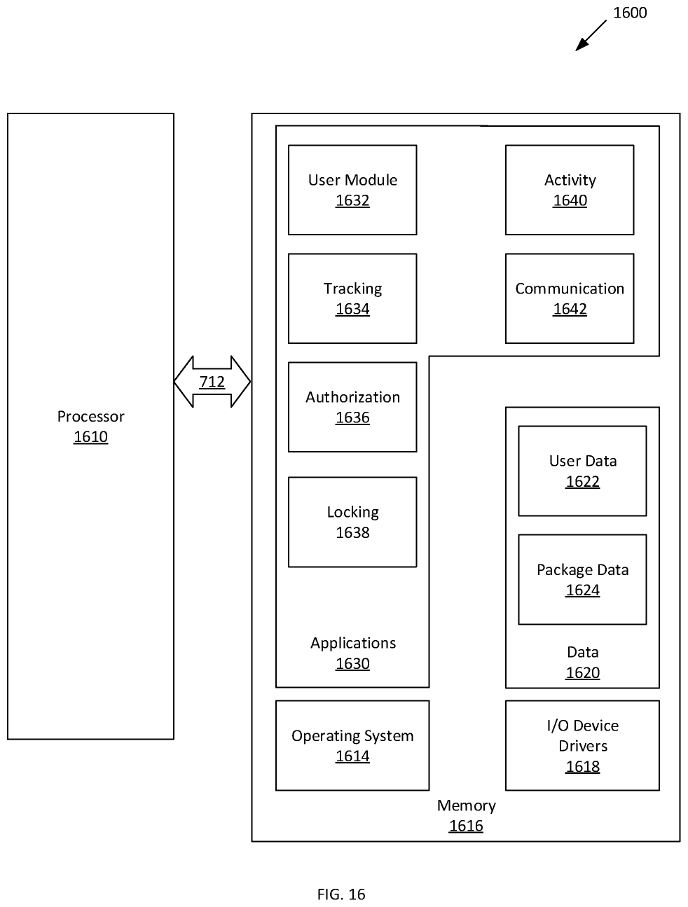

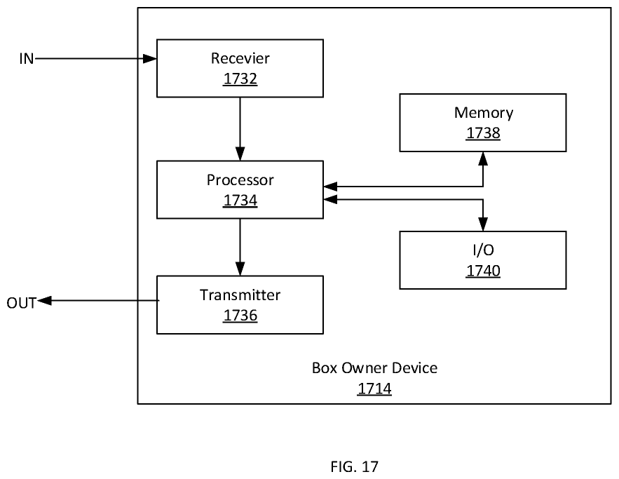

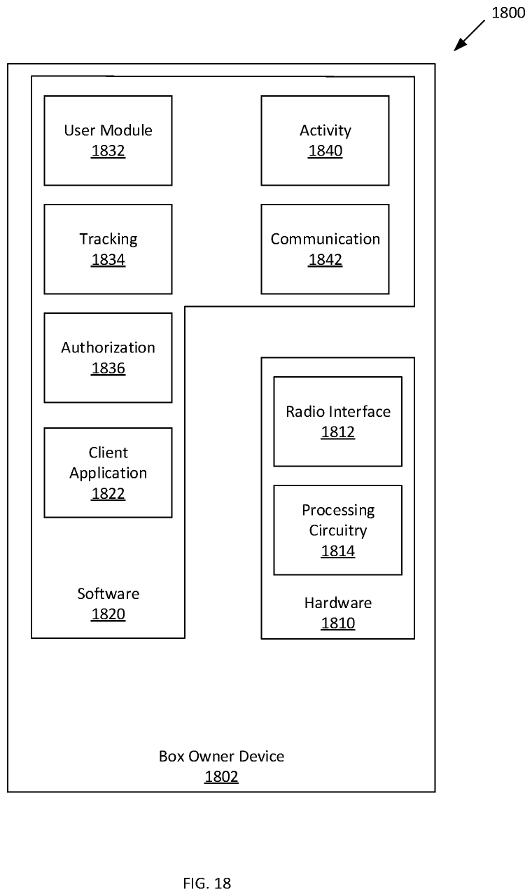

FIG. 16 is a block diagram of a data processing (computer) system that further illustrates systems, methods, and computer program products in accordance with embodiments of the present invention. The processor 1610 communicates with the memory 1616 via an address/data bus 1612. The processor 1610 can be any commercially available or custom microprocessor. The memory 1616 is representative of the overall hierarchy of memory devices containing the software and data used to implement the functionality of the data processing system 1600. The memory 1616 can include, but is not limited to, the following types of devices: cache, ROM, PROM, EPROM, EEPROM, flash memory, SRAM, and DRAM.

As shown in FIG. 16, the memory 1616 may include several categories of software and data used in the data processing system 1600: the operating system 1614; the application programs 1630; the input/output (I/O) device drivers 1618; and the data 1620. As will be appreciated by those of skill in the art, the operating system 1614 may be any operating system suitable for use with a data processing system, such as Solaris from Sun Microsystems, OS/2, AIX or System390 from International Business Machines Corporation, Armonk, N.Y., Windows95, Windows98, Windows NT, Windows ME, Windows XP or Windows 2000 from Microsoft Corporation, Redmond, Wash., Unix or Linux. The I/O device drivers 1618 typically include software routines accessed through the operating system 1614 by the application programs 1630 to communicate with devices such as the I/O data port(s) 1618 and certain memory 1616 components. The application programs 1630 are illustrative of the programs that implement the various features of the data processing system 1600 and preferably include at least one application that supports operations according to embodiments of the present invention. Finally, the data 1620 represents the static and dynamic data used by the application programs 1630, the operating system 1614, the I/O device drivers 1618, and other software programs that may reside in the memory 1616.

As is further seen in FIG. 16, the application programs 1630 may include a user module 1632, a tracking module 1634, an authorization module 1636, a locking module 1638, an activity module 1640 and a communication module 1642. The inclusion of these modules is illustrative and not meant to be limiting. Those skilled in the art will recognize that other application programs may be included. The user module 1632 is configured to store user data including but not limited to the user's name, the physical address of the delivery box, at least one email address and a phone number.

The tracking module 1634 is configured to receive and store authorized incoming package tracking data, such as a package tracking number, the delivery company, i.e. carrier name, order number, etc. for packages that are in route to be delivered to the physical location of the delivery box. This data will be used with the authentication of requests to engage the delivery box's locking mechanism in an attempt to gain access into the delivery box's internal compartment. The incoming package tracking data may be received from a direct input from a user or a delivery company over a communication network or may be obtained from an analysis of incoming email messages to the user's at least one email address and the text messages to the user's phone number to determine authorized incoming package tracking data.

The authorization module 1636 configured to receive a request to unlock the locking mechanism of delivery box and configured to determine if the request is authorized. The request may be in the form of package tracking data. In some embodiments, this data may be obtained from a bar code affixed to the package and scanned into the system by an agent of the delivery company. In these embodiments, the authorization module is configured to determine if the package tracking data is authorized by comparing the package tracking data with the stored incoming package tracking data. If the package tracking data matches the stored incoming package tracking data, the request will be determined to be authorized.

In some embodiments, the data is in the form of a passcode. The authorization module is configured to determine if the passcode is authorized by comparing the passcode with a list of authorized passcodes. The passcode may be preset by the user or a third party. The passcode may also be randomly generated by the authentication module or by a third-party random generation system. The passcode may be input directly into the delivery box through an input device, such as a keypad, or electronically from a user device. Further, the passcode may be input from a third-party from whom has received the passcode from the user. In these embodiments, the passcode may be permanent or may expire after a set amount of time. For example, a user is traveling for two weeks and has asked a neighbor to retrieve packages from the delivery box while the user is traveling. The user sends the neighbor a passcode that is active for the two weeks of travel. This allows the neighbor to gain access into delivery box by the use of the passcode during the two weeks of travel, after which the passcode expires and is no longer effective.

The locking module 1638 is configured to engage the locking mechanism upon a determination that the request to unlock the locking mechanism is authorized.

The activity module 1640 is configured to create and store an activity record for all activity associated with the delivery box. The activity record may include a time and a date of all successful and unsuccessful attempts to gain access to the compartment. Further, the activity record may include a video of the exterior of the delivery box for all successful and unsuccessful attempts to gain access to the compartment. This activity record may be transmitted to the user or to a storage device attached to a communication network.

The communication module 1642 is configured to provide and store communication between a person located at the delivery box and a remotely located person. This communication may be two-way between the persons and may include audio, video or both.

The data portion 1620 of memory 1616, as shown in the embodiments of FIG. 16, may include various types of data, such as user data 1622 and package data 1624. The user data 1622, as discussed above, may include information received from the user module 1632. Similarly, the package data 1624 may include data relating to the packages that are in route for delivery and those packages that have previously been received.

While the present invention is illustrated, for example, with reference to the tracking module 1634 being an application program in FIG. 16, as will be appreciated by those of skill in the art, other configurations may also be utilized while still benefiting from the teachings of the present invention. For example, the tracking module 1634 may also be incorporated into the operating system 1614 or other such logical division of the data processing system 1600. Thus, the present invention should not be construed as limited to the configuration of FIG. 16 but is intended to encompass any configuration capable of carrying out the operations described herein.

Furthermore, while each of the user module 1632, tracking module 1634, authorization module 1636, locking module 1638, activity module 1640 and communication module 1642 are illustrated in a single data processing system, as will be appreciated by those of skill in the art, such functionality may be distributed across one or more data processing systems. For example, the functionality of the tracking module 1634 may be provided on one or more data processing (computer) systems that are separate from the data processing system that provides the functionality of the authorization module 1636. Thus, the present invention should not be construed as limited to the configuration illustrated in FIGS. 14-16, and may be provided by other arrangements and/or division of function between data processing systems.

In some embodiments, the ability to open or unlock the back door, i.e. see FIG. 1, second door 110, to allow access through the delivery box may be manually performed by the owner, or administrator, of the delivery box, whether located remotely or locally to the delivery box. This may be performed when, for example, the administrator is aware that a package of a size larger than the delivery box is to be delivered and would prefer to have the package inserted through the delivery box into the interior of the attached building instead of having a failed delivery.

In some embodiments, the ability to unlock the back door may be automatic based on received information regarding a delivered package. For example, when a package includes a QR code or other similar tag and that QR code includes the dimensions of the package, upon the scanning or other input of this QR code, the system may determine the package to be delivered would not fit inside the delivery box. The system may automatically unlock the back door to allow the package to be passed through the delivery box and into the interior of the attached building.

FIG. 17 is a detailed diagram showing the overall components of an embodiment of a box owner device 1714 according to the present invention. Referring now to FIG. 17, the box owner device 1714 may be any type of user equipment (UE), such as a mobile phone, that is capable of sending and receiving data across a network, such as a wireless telecommunications system. Box owner device 1714 may include a receiver 1732, a processor 1734, a memory 1738 and a transmitter 1736. When a request for information is received or when data is needed to be transmitted, the requested information or transmitted data is preferably processed by processor 1734. Processor 1734 preferably accesses memory 1738 to fetch the requested information and transmits the data, as appropriate, via transmitter 1736. Box owner device 1714 is preferably powered by a power source, not shown. Box owner device 1714 may operate in standalone mode or in concert with other wireless short-range devices.

Box owner device 1714 may support such features as, for example receiving and storing user data, receiving and storing authorized incoming package tracking data, determining if a request to unlock the locking mechanism of delivery box is authorized and engaging the locking mechanism upon a determination that the request to unlock the locking mechanism is authorized. Inputs to box owner device 1714 may be made via voice (voice mail), locally input and/or remotely, for example via I/O 1740. For example, upon the input of an authorized bar code scan by a delivery agent through a scanner (e.g. the scanner 1422 in FIG. 14), box owner device 1714 may remotely provide instructions to the electronic lock 1414 to release the lock allowing for access to compartment 1416 in FIG. 14.

Box owner device 1714 would typically be able track the successful and unsuccessful attempts to gain access into the compartment 1416.

Memory 1738 preferably stores records of significant information and events such as the delivery of packages, the tracking data for packages, the identification of delivery companies and the identification of authorized persons for access purposes.

Preferably, receiver 1732 is capable of receiving information from delivery box management system 1514 or delivery agent device 1518. Such information can typically include, but is not limited to, information regarding requests to unlock the locking mechanism along with authentication data, such as passcode data, to authentic requests to unlock the locking mechanism.

In some embodiments, upon the successful delivery of a package, box owner device 1714 may also be configured receive a notification, such a text message or email, from the delivery box management system 1514, for example over the wireless network 1430 in FIG. 14, that the package has been delivered and is secured within the delivery box.

FIG. 18 is a block diagram of a data processing (computer) system within a box owner device 1802, otherwise referred to as user equipment (UE) that further illustrates systems, methods, and computer program products in accordance with embodiments of the present invention.

UE 1802 may include hardware 1810 having a radio interface 1812 configured to set up and maintain a wireless connection 1850 with a base station serving a coverage area in which the UE 1802 is currently located. The hardware 1810 of the UE 1802 further includes processing circuitry 1814, which may comprise one or more programmable processors, application specific integrated circuits, field programmable gate arrays or combinations of these (not shown) adapted to execute instructions. The UE 1802 further comprises software 1820, which is stored in or accessible by the UE 1802 and executable by the processing circuitry 1814. The software 1820 includes a client application 1822. The client application 1822 may be operable to provide a service to a human or non-human user via the UE 1802.

As is further seen in FIG. 18, software 1820 may also include a user module 1832, a tracking module 1834, an authorization module 1836, an activity module 1840 and a communication module 1842. The inclusion of these modules is illustrative and not meant to be limiting. Those skilled in the art will recognize that other application programs may be included. The user module 1832 is configured to store user data including but not limited to the user's name, the physical address of the delivery box, at least one email address and a phone number.

The tracking module 1834 is configured to receive and store authorized incoming package tracking data, such as a package tracking number, the delivery company, i.e. carrier name, order number, etc. for packages that are in route to be delivered to the physical location of the delivery box. This data will be used with the authentication of requests to engage the delivery box's locking mechanism in an attempt to gain access into the delivery box's internal compartment. The incoming package tracking data may be received from a direct input from a user or a delivery company over a communication network or may be obtained from an analysis of incoming email messages to the user's at least one email address and the text messages to the user's phone number to determine authorized incoming package tracking data.

The authorization module 1636 configured to receive a request to unlock the locking mechanism of delivery box and configured to determine if the request is authorized. The request may be in the form of package tracking data. In some embodiments, this data may be obtained from a bar code affixed to the package and scanned into the system by an agent of the delivery company. In these embodiments, the authorization module is configured to determine if the package tracking data is authorized by comparing the package tracking data with the stored incoming package tracking data. If the package tracking data matches the stored incoming package tracking data, the request will be determined to be authorized.

In some embodiments, the data is in the form of a passcode. The authorization module is configured to determine if the passcode is authorized by comparing the passcode with a list of authorized passcodes. The passcode may be preset by the user or a third party. The passcode may also be randomly generated by the authentication module or by a third-party random generation system. The passcode may be provided to a third-party. In these embodiments, the passcode may be permanent or may expire after a set amount of time. For example, a user is traveling for two weeks and has asked a neighbor to retrieve packages from the delivery box while the user is traveling. The user sends the neighbor a passcode that is active for the two weeks of travel. This allows the neighbor to gain access into delivery box by the use of the passcode during the two weeks of travel, after which the passcode expires and is no longer effective.

The activity module 1840 is configured to create and store an activity record for all activity associated with the delivery box. The activity record may include a time and a date of all successful and unsuccessful attempts to gain access to the compartment. Further, the activity record may include a video of the exterior of the delivery box for all successful and unsuccessful attempts to gain access to the compartment. This activity record may include data transmitted from the delivery box to the UE 1802.

The communication module 1842 is configured to provide and store communication between a person located at the delivery box and the UE 1802. This communication may be two-way between the persons and may include audio, video or both.

The various embodiments further can be implemented in a wide variety of operating environments, which in some cases can include one or more user computers, computing devices or processing devices which can be used to operate any of a number of applications. User or client devices can include any of a number of general purpose personal computers, such as desktop or laptop computers running a standard operating system, as well as cellular, wireless and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems and other devices capable of communicating via a network.

Most embodiments utilize at least one network that would be familiar to those skilled in the art for supporting communications using any of a variety of commercially-available protocols, such as Transmission Control Protocol/Internet Protocol (“TCP/IP”), Open System Interconnection (“OSI”), File Transfer Protocol (“FTP”), Universal Plug and Play (“UpnP”), Network File System (“NFS”), Common Internet File System (“CIFS”) and AppleTalk. The network can be, for example, a local area network, a wide-area network, a virtual private network, the Internet, an intranet, an extranet, a public switched telephone network, an infrared network, a wireless network, and/or any combination thereof.

In embodiments utilizing a Web server, the Web seer can run any of a variety of server or mid-tier applications, including Hypertext Transfer Protocol (“HTTP”) servers, FTP servers, Common Gateway Interface (“CGP”) servers, data servers, Java servers and business application servers. The server(s) also may be capable of executing programs or scripts in response requests from user devices, such as by executing one or more Web applications that may be implemented as one or more scripts or programs written in any programming language, such as Java®, C, C # or C++, or any scripting language, such as Pert, Python or TCL, as well as combinations thereof. The server(s) may also include database servers, including without limitation those commercially available from Oracle®, Microsoft®, Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (“SAN”) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (“CPU”), at least one input device (e.g., a mouse, keyboard, controller, touch screen or keypad) and at least one output device (e.g., a display device, printer or speaker). Such a system may also include one or more storage devices, such as disk drives, optical storage devices and solid-state storage devices such as random access memory (“RAM”) or read-only memory (“ROM”), as well as removable media devices, memory cards, flash cards, etc.

Such devices also can include a computer-readable storage media reader, a communications device (e.g., a modem, a network card (wireless or wired), an infrared communication device, etc.) and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services or other elements located within at least one working memory device, including an operating system and application programs, such as a client application or Web browser. It should be appreciated that alternate embodiments may have numerous variations from that described above. For example, customized hardware might also be used and/or particular elements might be implemented in hardware, software (including portable software, such as applets) or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules or other data, including RAM, ROM, Electrically Erasable Programmable Read-Only Memory (“EEPROM”), flash memory or other memory technology, Compact Disc Read-Only Memory (“CD-ROM”), digital versatile disk (DVD) or other optical storage, magnetic cassettes, magnetic tape, magnetic disk storage or other magnetic storage devices or any other medium which can be used to store the desired information and which can be accessed by the a system device. Based at least in part on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions and equivalents falling within the spirit and scope of the invention, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this disclosure are described herein, including the best mode known to the inventors for carrying out the invention. Variations of those preferred embodiments may become apparent to those of ordinary skill in the art upon reading the foregoing description. The inventors expect skilled artisans to employ such variations as appropriate and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

All references, including publications, patent applications and patents, cited herein are hereby incorporated by reference to the same extent as if each reference were individually and specifically indicated to be incorporated by reference and were set forth in its entirety herein.

While preferred embodiments of the present inventive concept have been shown and disclosed herein, it will be obvious to those persons skilled in the art that such embodiments are presented by way of example only, and not as a limitation to the scope of the inventive concept. Variations, changes, and substitutions may occur or be suggested to those skilled in the art without departing from the intent, scope, and totality of this inventive concept. Such variations, changes, and substitutions may involve other features which are already known per se and which may be used instead of, in combination with, or in addition to features already disclosed herein. Accordingly, it is intended that this inventive concept be inclusive of such variations, changes, and substitutions, and by no means limited by the scope of the claims presented herein.

1. A delivery box, comprising:
a first door providing access to a compartment;
a first locking mechanism configured to lock and unlock the first door; and
a computer device having a processor and a memory configured for engaging the first locking mechanism to lock and unlock the first door.

2. The delivery box of claim 1, wherein the locking mechanism is further defined as an electronic lock configured to operate upon receiving authenticated electronic key input.

3. The delivery box of claim 1, wherein the locking mechanism is further defined as a combination electronic and mechanical lock configured to operate by a combination of a physical key and electronic key input.

4. The delivery box of claim 1, further comprising:
a parcel scanning device configured to scan encoded parcel tracking numbers;
a camera configured to provide video coverage of the delivery box;
a communication device configured to provide two-way communication between a person located at the delivery box and a remotely located person;
an input device configured to provide direct input to the computer device; and
an exterior light configured to provide illumination to the exterior of the delivery box.

5. The delivery box of claim 1, wherein the input device is a keypad.

6. The delivery box of claim 1, wherein the input device is a biometric input device.

7. The delivery box of claim 1, further comprising:
a second door providing access to the storage space; and
a second locking mechanism configured to lock and unlock the second door,
wherein the computer device is further configured for engaging the second locking mechanism to lock and unlock the second door.

8. A delivery box system for use by a user with a delivery box having an internal compartment, a door providing access into the internal compartment and a locking mechanism configured to lock and unlock the door, the system comprising:
a user module configured to receive and store user data;
a tracking module configured to receive and store authorized incoming package tracking data;
an authorization module configured to receive a request to unlock the locking mechanism of delivery box and configured to determine if the request is authorized;
a locking module configured to engage the locking mechanism upon a determination that the request to unlock the locking mechanism is authorized;
an activity module configured to create and store an activity record for all activity associated with the delivery box, the activity record includes a time and a date of all successful and unsuccessful attempts to gain access to the compartment; and
a communication module configured to provide and store two-way audio and video communication between a person located at the delivery box and a remotely located person.

9. The delivery box system of claim 8, wherein the user data includes the user name, the delivery box's physical address, at least one user email address and the user's phone number.

10. The delivery box system of claim 8, wherein the tracking module is configured receive authorized incoming package tracking data from user input and delivery company input.

11. The delivery box system of claim 8, wherein the tracking module is configured analysis incoming email messages to the user's at least one email address and the text messages to the user's phone number to determine authorized incoming package tracking data.

12. The delivery box system of claim 8,
wherein the request is in the form of a package tracking data, and,
wherein the authorization module configured to determine if the package tracking data is authorized by comparing the package tracking data with the incoming package tracking data.

13. The delivery box system of claim 8,
wherein the request is in the form a passcode, and
wherein the authorization module is configured to determine if the passcode is authorized by comparing the passcode with a list of authorized passcodes.

14. The delivery box system of claim 8, wherein the delivery box comprises:
a first door providing access to a compartment;
a first locking mechanism configured to lock and unlock the first door; and
a computer device having a processor and a memory configured for engaging the first locking mechanism to lock and unlock the first door.

15. The delivery box system of claim 14, wherein the locking mechanism is further defined as an electronic lock configured to operate upon receiving authenticated electronic key input.

16. The delivery box system of claim 14, wherein the locking mechanism is further defined as a combination electronic and mechanical lock configured to operate by a combination of a physical key and electronic key input.

17. The delivery box system of claim 14, further comprising:
a parcel scanning device configured to scan encoded parcel tracking numbers;
a camera configured to provide video coverage of the delivery box;
a communication device configured to provide two-way communication between a person located at the delivery box and a remotely located person;
an input device configured to provide direct input to the computer device; and
an exterior light configured to provide illumination to the exterior of the delivery box.

18. The delivery box system of claim 14, wherein the input device is a keypad.

19. The delivery box system of claim 14, wherein the input device is a biometric input device.

20. The delivery box system of claim 14, further comprising:
a second door providing access to the storage space; and
a second locking mechanism configured to lock and unlock the second door,
wherein the computer device is further configured for engaging the second locking mechanism to lock and unlock the second door.
